(19) United States
(12) Patent Application Publication
(10) Pub. No.: US 2023/0342253 A1
(43) Pub. Date: Oct. 26, 2023

(54) INTELLIGENT FILE SYSTEM CRAWLING FOR PROTECTION OPERATION

(71) Applicant: Dell Products L.P., Round Rock, TX (US)

(72) Inventors: Aaditya Bansal, Bangalore (IN); Shelesh Chopra, Bangalore (IN); Sunil Yadav, Bangalore (IN); Manish Sharma, Bangalore (IN)

(21) Appl. No.: 17/724,646

(22) Filed: Apr. 20, 2022

(51) Int. Cl. G06F 11/14

(52) U.S. Cl. CPC G06F 11/1435; G06F 11/1464; G06F 11/1469; G06F 11/1451; G06F 2201/80

(57) ABSTRACT

One or more embodiments of the invention performs an incremental backup by crawling only those folders which have changed. By comparing a folder's attributes with those in a backup's meta-data, an intelligent file system crawler can determine if the underlying files and sub-folders of the folder have undergone a change. If they have, then the one or more embodiments of the invention proceeds to crawl the underlying sub-folders. If the folder's attributes have not changed, then the intelligent file system crawler of one or more embodiments of the invention proceeds to the next folder and does not crawl the underlying sub-folders. By doing this, one or more embodiments of the invention can crawl the entire file system quicker, since those folders that have not undergone a change since the last backup was performed, do not have their sub-folders crawled.

### BACKGROUND

As people increasingly rely on computing systems and devices to perform many tasks; the systems have become increasingly complex, and the opportunities for failure and/or loss of important data has also increased. To prevent loss of important data, performing a backup on the file system of a computing system is necessary to prevent loss of data if a system failure occurs or cyberattacks such as ransomware are directed towards the system. File system backups leverage a file-based backup philosophy to protect the underlying data. This underlying mechanism is leveraged not just to protect the file system on a host, but also to protect workflows in network attached storage.

### SUMMARY

In general, certain embodiments described herein relate to a method for performing an incremental backup on a target file system of a target production host. The method comprises of identifying a folder in the target file system that is to be backed up. The method incrementally crawls each underlying sub-folder of the folder, when the folder's current attributes are different than the folder's attributes stored in the previous backup's meta-data. When the folder's current attributes are the same as the sub-folder's attributes stored in the previous backup's meta-data, the method does not crawl the underlying sub-folders of the folder. The method then indicates that each underlying sub-folder that has current attributes different from that of the attributes stored in the previous backup's meta-data, is to be backed up.

In general, certain embodiments described herein relate to a non-transitory computer readable medium comprising computer readable program code, which when executed by a computer processor enables the computer processor to perform a method for performing a backup. The method comprises of identifying a folder in the target file system that is to be backed up. The method incrementally crawls each underlying sub-folder of the folder, when the folder's current attributes are different than the folder's attributes stored in the previous backup's meta-data. When the folder's current attributes are the same as the sub-folder's attributes stored in the previous backup's meta-data, the method does not crawl the underlying sub-folders of the folder. The method then indicates that each underlying sub-folder that has current attributes different from that of the attributes stored in the previous backup's meta-data, is to be backed up.

In general, certain embodiments described herein relate to a system comprising: a storage device associated with a target production host that includes a target file system comprising of folders and files, a processor, and memory. The memory includes instructions, which when executed by the processor, perform a method for performing a backup. The method comprises of identifying a folder in the target file system that is to be backed up. The method incrementally crawls each underlying sub-folder of the folder, when the folder's current attributes are different than the folder's attributes stored in the previous backup's meta-data. When the folder's current attributes are the same as the sub-folder's attributes stored in the previous backup's meta-data, the method does not crawl the underlying sub-folders of the folder. The method then indicates that each underlying sub-folder that has current attributes different from that of the attributes stored in the previous backup's meta-data, is to be backed up.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a backup system in accordance with one or more embodiments of the invention.

FIG. 3 shows a flowchart of a method of generating a backup in accordance with one or more embodiments of the invention.

FIG. 4 shows a flowchart of a method of crawling sub-folders in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures.

In the following description of the figures, any component described with regards to a figure, in various embodiments of the invention, may be equivalent to one or more like-named components described with regards to any other figure. For brevity, descriptions of these components will not be repeated with regards to each figure. Thus, every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regards to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or preceded) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, when performing an incremental backup of a file system, the entire file system including all folders and files are crawled to determine which folders and/or files have been modified or are new since a previous successfully completed backup which can either be a full backup or another incremental backup previously completed. Those that are found to have been modified or are new, are then added to the incremental backup. This in general requires crawling each-and-every sub-folder of a folder, even if no change has occurred to a folder.

To improve this process, one or more embodiments of the invention crawls only those folders which have changed. By comparing a folder's attributes with those in a backup's meta-data, an intelligent file system crawler can determine if the underlying files and sub-folders of the folder have undergone a change. If they have, then the one or more embodiments of the invention proceeds to crawl the underlying sub-folders. If folder's attributes have not changed, then the intelligent file system crawler of one or more embodiments of the invention proceeds to the next folder. By doing this, one or more embodiments of the invention can crawl the entire file system quicker, since those folders that have not undergone a change since the last backup was performed, do not have their sub-folders crawled.

The following describes various embodiments of the invention.

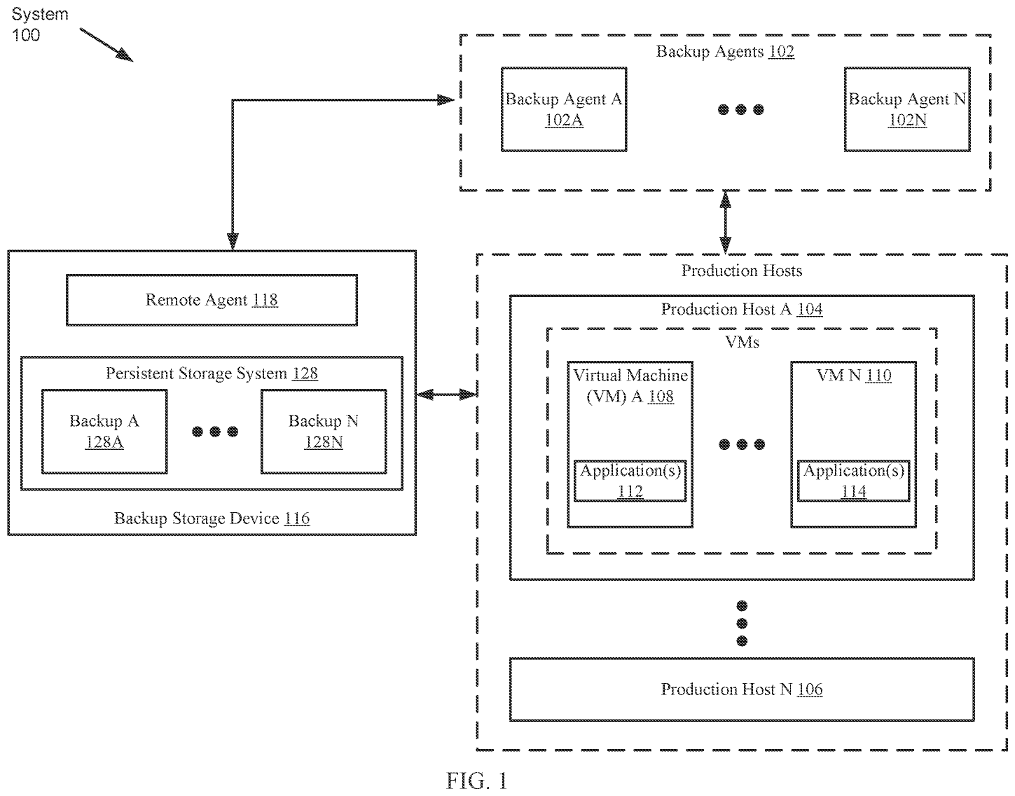

FIG. 1 shows a diagram of a system in accordance with one or more embodiments of the invention. The system includes backup agents (102), production hosts (104, 106), a backup storage device (116), and a remote agent (118). The system may include additional, fewer, and/or different components without departing from scope of the invention. Each component may be operably connected to any of the other component via any combination of wired and/or wireless connections. Each component illustrated in FIG. 1 is discussed below.

In one or more embodiments of the invention, the backup agents (102A-102N) may generate and provide to the backup storage device (116) the backups and the historical meta-data based on backup policies implemented by the backup agent (102). The backup policies may specify a schedule in which the applications (e.g., 114) or other assets associated with the applications are to be backed up. The backup agent (102) may be triggered to generate a backup and historical meta-data and provide the backup and historical meta-data to the backup storage device (116) in response to a backup policy. Alternatively, backup, and historical meta-data may be generated by the backup agent (102) and provided to the backup storage device (116) in response to a backup request triggered by the client(s) and/or users. The backup request may specify the applications(s) (114) and/or assets associated with the applications (114) to be backed up.

In one or more embodiments of the invention, the backup agent (102) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the backup agent (102) described throughout this application.

In one or more embodiments of the invention, the backup agent (102) is implemented as computer instructions, e.g., computer code, stored on a persistent storage that when executed by a processor of the production hosts (104, 106) causes the production hosts (104, 106) to provide the functionality of the backup agents (102) described throughout this application.

In one or more embodiments of the invention, the production host (104, 106), hosts one or more applications (112, 114). In one or more embodiments of the invention, the application(s) (112, 114) perform computer implemented services for clients and/or users. Performing the computer implemented services may include performing operations on asset data that is stored in the production host (e.g., 104). The operations may include creating elements of assets, moving elements of assets, modifying elements of assets, deleting elements of assets, and other and/or additional operations on asset data without departing from the invention. The application(s) (112, 114) may include functionality for performing the aforementioned operations on the asset data in the production host (104, 106). The application(s) (112, 114) may be, for example, instances of databases, email servers, and/or other applications. The production host (104, 106) may host other types of applications without departing from the invention.

In one or more of embodiments of the invention, the application(s) (112, 114) is implemented as computer instructions, e.g., computer code, stored on a persistent storage that when executed by a processor(s) of the production hosts (104, 106) cause the production host (104, 106) to provide the functionality of the application(s) (112, 114) described throughout this application.

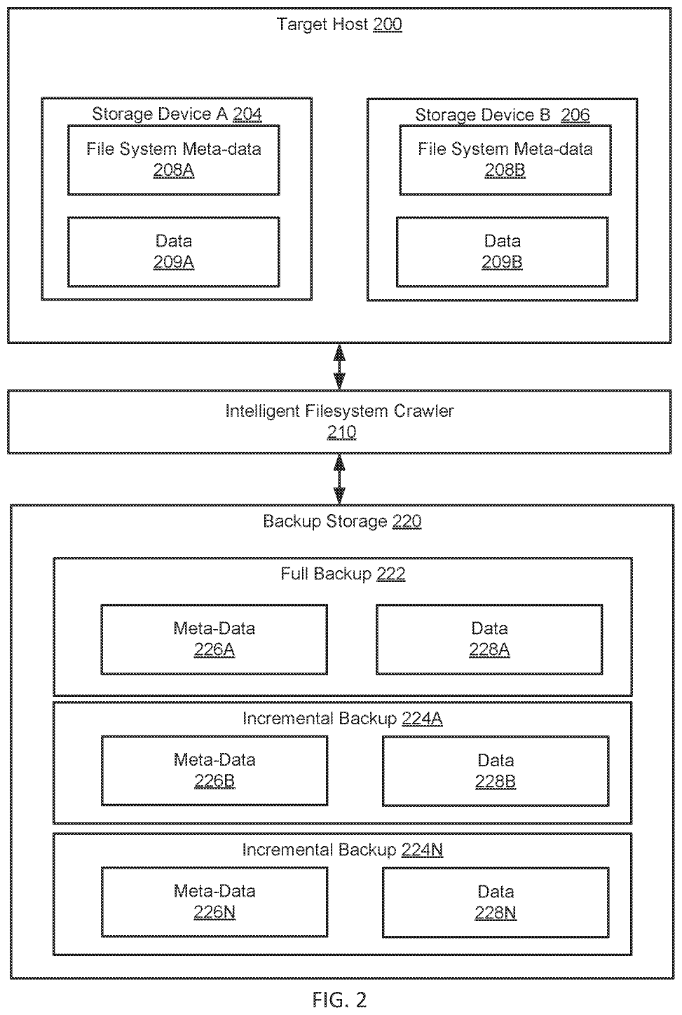

The production hosts (104, 106) may include physical storage or logical storage that will be discussed in more detail with regards to FIG. 2. The logical storage devices (e.g., virtualized storage) may utilize any quantity of hardware storage resources of any number of computing devices for storing data. For example, the persistent storage may utilize portions of any combination of hard disk drives, solid state disk drives, tape drives, and/or any other physical storage medium of any number of computing devices.

In one or more embodiments of the invention, the backup agents (102) may be a portion of the remote agents (118). The remote agents (118) and/or backup agents (102) may provide backup services to the production hosts (104, 106). The backup services may include generation and storage of backups in the backup storage device (116). The backups services may also include restoration of the production hosts (104, 106) using the backups stored in the backup storage device (116).

The remote agents (118) may provide backup services to the production hosts (104, 106) by orchestrating: (i) generation of backups of the production hosts (104, 106), (ii) storage of backups (128A, 128N) of the production hosts (104, 106) in the persistent storage system (128) of the backup storage device (116), (iii) consolidation of backup requests to reduce or prevent from generation of backups that are not useful for restoration purposes, and (iv) restoration of the production hosts (104, 106) to previous states using backups (128A, 128N) stored in the persistent storage system (128) of the backup storage device (116). The system may include any number of remote agents (e.g., 102A, 102N) without departing from the scope of the invention.

Additionally, to provide the backup services, the remote agent (118) may include functionality to generate and issue instructions to any component of the system of FIG. 1. In one or more embodiments, the remote agent (118) may also generate instructions in response to backup requests from other entities.

In one or more embodiments of the invention, the remote agent (118) may generate such instructions in accordance with backup schedules that specify when backups are to be generated. In one or more embodiments, a backup schedule may lay out specific points in time for a backup process to be performed.

In one or more embodiments of the invention, to satisfy the above-discussed backup schedules, the remote agent (118) may monitor a backup window (e.g., 4 hours, 8 hours, etc.) to perform a single backup and/or multiple backups. Additionally, the remote agent (118) may pause an ongoing backup if the backup exceeded the backup window. The remote agent (118) may then resume the paused backup while performing a next backup in a parallel manner based on the backup schedule.

In one or more embodiments of the invention, the backup storage device (116) may provide data storage services. For example, the backup storage device (116) may store backups of the production hosts (104, 106) in persistent storage system (128). The persistent storage system (128) may also provide copies of the latest backup N (128N) previously stored backups (128A) of the production hosts (104, 106). The system may include any number of backup storage devices (116) and backups (128A, 128N) without departing from the scope of the invention.

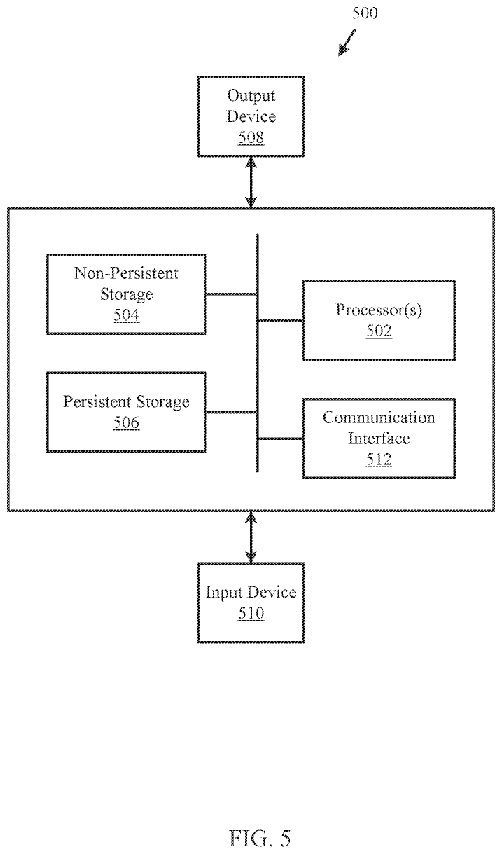

In one or more embodiments of the invention, the backup storage device (116) and persistent storage system (128) may be implemented as computing devices (e.g., 500, FIG. 5). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device, cause the computing device to perform the functionality of the backup storage device (116) described throughout this application. Alternatively, in one or more embodiments of the invention, the backup storage devices (116) may also be implemented as logical devices, as discussed above.

In one or more embodiments of the invention, the production hosts (104, 106) may provide services to the users. For example, the production hosts (104, 106) may host any number of applications that provide application services to the users. Application services may include, but are not limited to database services, electronic communication services, instant messaging services, file storage services, etc.

In one or more embodiments of the invention, each of the production hosts (e.g., 104-106) may provide the above-discussed application services by hosting applications. Each of the production hosts may host any number of applications. Additionally, different production hosts may host the same number of applications or different numbers of applications. Different production hosts may also host similar or different applications.

In one or more embodiments of the invention, the production hosts (104, 106) may host virtual machines (VMs, e.g., 108-110) that host the above-discussed applications. Each of the production hosts (104, 106) may host any number of VMs that, in turn, host any number of applications.

In one or more embodiments of the invention, the production hosts (104, 106) may perform portions of a backup process. For example, the production hosts (104, 106) may initiate backups under the direction of the remote agent (118) or backup agents (102). In one or more embodiments, the production hosts (104, 106) may include functionality to consolidate multiple backup generation requests so that duplicative backups are not generated, because the duplicative backups may not be useful for restoration purposes.

In one or more embodiments of the invention, the production hosts (104, 106) may include functionality to initiate multiple backups in a parallel manner. For example, the production hosts (104, 106) may each host multiple backup processes that each manages the initiation of a respective backup. Each of the multiple backup processes may operate concurrently thereby causing multiple backups to be initiated in a parallel manner.

In one or more embodiments of the invention, the production hosts (104, 106) may be implemented as computing devices (e.g., 500, FIG. 5). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device, cause the computing device to perform the functionality of the production hosts (104, 106) described throughout this application.

Alternatively, in one or more embodiments of the invention, the production hosts (104, 106) may also be implemented as logical devices, as discussed above.

Turning now to FIG. 2, FIG. 2 shows a diagram of specific components utilized in performing a backup of a target production host (200) in accordance with one or more embodiments of the invention. The target production host (200) communicates with an intelligent file system crawler (210) and with a backup storage device (220). Each component illustrated in FIG. 2 is discussed below.

The target production host (200) may be similar to the production hosts (104, 106) as discussed above in reference to FIG. 1. The target production host (200) may include VMs, a hypervisor, a production agent, and storage devices (e.g., 204 and 206). The production host may include additional, fewer, and/or different components without departing from scope of the invention. Each component may be operably connected to any of the other component via any combination of wired and/or wireless connections.

As discussed above, the production host may provide computer implemented services to the client(s) and/or users and obtain backup storage services from the backup storage device (220). To provide and obtain the aforementioned computer implemented services and the backup storage services, the production host may include a backup agent (102), application(s) (112, 114), and persistent storage (128). The production host may include other and/or additional components without departing from the invention.

The backup storage device (220) is the same or substantially similar to the backup storage device in FIG. 1. The backup storage device (220) stores a backup created at least in part by the intelligent file system crawler (210), which crawls the data in the target production host (200).

Target production host (200) include storage devices, e.g., 204, 206. The storage devices include a file system meta-data repository (208A) and data (209A). A file system meta-data repository (208A) may be one or more data structures that include information regarding applications stored in the file system repository. The information included in the file system meta-data repository (208A) may be used by the backup agent to generate backups and historical meta-data. The file system meta-data repository (208A) may include other and/or additional information without departing from the invention.

The file system meta-data repository, e.g., 208A and 208B, may include one or more data structures that may be used to generate backups of assets of a target file system of a target production host. The file system meta-data repository e.g., 208A and 208B, may include asset data generated by users of the application(s) (112, 114) as discussed above. The asset data may be any type of data such as database data and email data generated by users of the application(s) (112, 114) without departing from the invention. Each application of the application(s) (112, 114) may include any number of assets, each asset may include any quantity of asset data, and furthermore, each asset may include any number of elements without departing from the invention. Users may use the data, e.g., 209A and 209B, stored on the storage devices, e.g., 204 and 206, when obtaining computer implemented services from the target production host (200). Additionally, the target data, e.g., 209A and 209B, stored on the storage devices, e.g., 204 and 206, of the target production host (200), may be obtained by intelligent file system crawler (210) to generate backups. The data e.g., 209A and 209B, of the file system meta-data storage devices, e.g., 204 and 206, may be used by other and/or additional entities for other and/or additional purposes without departing from the invention.

In one or more embodiments of the invention, the backup agents (e.g., 102, FIG. 1) include an intelligent file system crawler (210) to obtain backups (e.g., 222 and 224A-224N) including meta-data e.g., 226A-226N and data, e.g., 228A-226N from the target file system of the target production host (200). The meta-data and data are stored in the backup storage device (220). The intelligent file system crawler (210) may also include the functionality to provide backups (e.g., 222 and 224A-224N) to the production host (200, FIG. 2) for restoration purposes, history monitoring purposes, and/or other and/or additional purposes without departing from the invention. The intelligent file system crawler (210) may include other and/or additional functionalities without departing from the invention.

The meta-data e.g., 226A-226N and data e.g., 228A-228N of the backups e.g., 222 and 224A-224N (which were previously successfully completed), may be one or more data structures that include historical information associated with each backup e.g., 222 and 224 and aspects of the application(s) (112 and 114, FIG. 1). The historical information may include a list of files and folders that were backed-up as well as it may also include lists of files and folders that were skipped during previous successfully completed backups of the storage devices e.g., 204 and 206).

In one or more embodiments of the invention, the intelligent file system crawler (210) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the intelligent file system crawler (210) described throughout this application.

In one or more embodiments of the invention, the intelligent file system crawler (210) is implemented as computer instructions, e.g., computer code, stored on a persistent storage (220) that when executed by a backup agent (e.g., 102 of FIG. 1), causes a processor to provide the functionality of the intelligent file system crawler (210) described throughout this application.

In one or more embodiments of the invention, the backup storage (220) stores data related to the backup. The data stored in backup storage (220) may include backups of target data associated with applications of the target production host (200). The backup storage (220) may store any quantity of backups without departing from the invention. The backup storage (220) may store a full backup e.g., 222 or one or more incremental backups e.g., 224A-224N. The backup storage (220) may store other and/or additional data without departing from the invention.

The backup storage (220) may be implemented using physical storage devices and/or logical storage devices. The physical storage devices may include any combination of hard disk drives, solid state disk drives, tape drives, and/or any other physical storage mediums for the storage of data.

The logical storage devices (e.g., virtualized storage) may utilize any quantity of hardware storage resources of any number of computing devices for storing data. For example, the backup storage (220) may utilize portions of any combination of hard disk drives, solid state disk drives, tape drives, and/or any other physical storage medium of any number of computing devices.

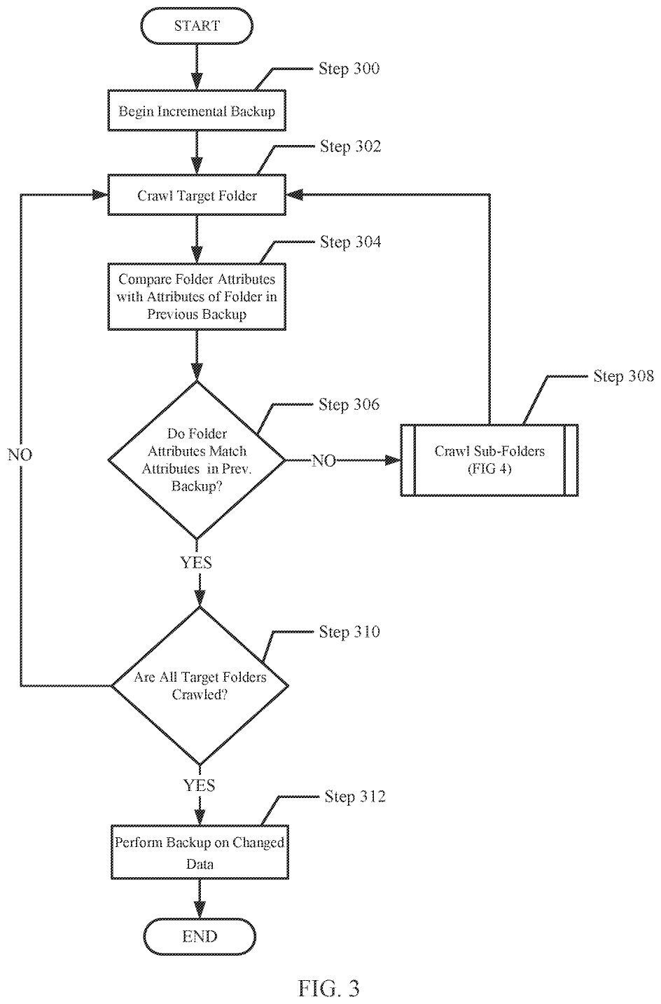

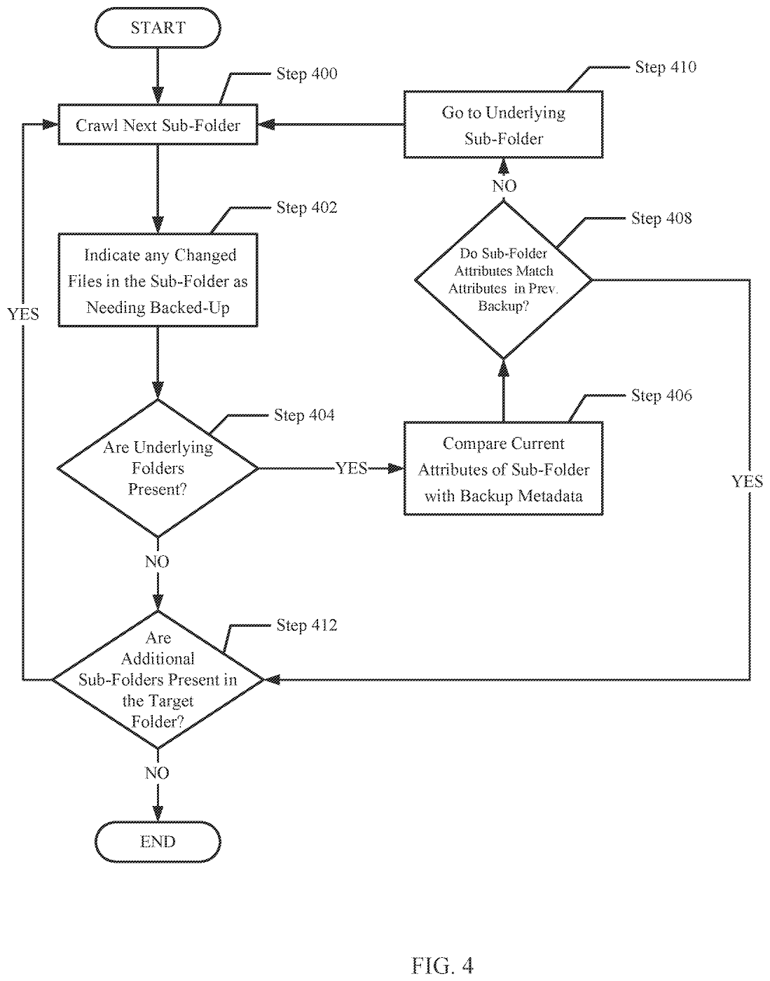

FIGS. 3 and 4 show a method to perform a backup in accordance with one or more embodiments of the invention. While the various steps in the method are presented and described sequentially, those skilled in the art will appreciate that some or all the steps may be executed in different orders, may be combined, or omitted, and some or all steps may be executed in a parallel manner without departing from the scope of the invention.

FIG. 3 shows a flowchart of a method of generating a backup in accordance with one or more embodiments of the invention. The method may be performed by, for example, a backup agent (102, FIG. 1) and/or intelligent file system crawler (210, FIG. 2) of a production host (104-106, FIG. 1). Other components of the system illustrated in FIG. 1 and FIG. 2 may perform all, or a portion of the method of FIG. 3 without departing from the invention.

While FIG. 3 is illustrated as a series of steps, any of the steps may be omitted, performed in a different order, additional steps may be included, and/or any or all the steps may be performed in a parallel and/or partially overlapping manner without departing from the invention.

In step 300, the system begins an incremental backup on the target production host (200, FIG. 2).

In one or more embodiments of the invention, the incremental backup is started based on a backup generation event that is identified by the backup agent as point in time. The point is time is specified by a backup policy associated with the generation of a backup of a target file system. Alternatively, in one or more embodiments of the invention, the incremental backup can be started after obtaining a message from a client requesting the generation of an incremental backup of the target file system. In one embodiment, the backup agent may include a backup policy associated with the target file system that specifies points in time to generate backups of the target file system. The backup agent may monitor the backup policy and identify when a point in time specified by the backup policy occurs.

The backup policy may include an identifier associated with the target corresponding with the backup policy. The identification of the point in time specified by the backup policy may result in the identification of the backup generation event by the backup agent. In another embodiment of the invention, a user of a client may send a message to the backup agent. The message may include a request to generate a backup of the target. The message may include an identifier associated with the target. The backup agent may identify obtaining the aforementioned message as the backup generation event. The backup generation event initiates a backup of a target may be identified via other and/or additional methods without departing from the invention.

In step 302, the backup agent causes the intelligent file system crawler (210, FIG. 2) to begin crawling the target production host and its file system (target file system).

In one or more embodiments of the invention an intelligent file system crawler which as described above is implemented in the backup agent or as a standalone agent/system for analyzing the contents of the target host's file system. The intelligent file system crawler analyzes each folder to determine if the folder and/or files within it are to be backed-up according to the policy and rules that generated the backup event. The intelligent file system crawler also determines if there are rules or other reasons that the file or folder cannot be backed up. The intelligent file system crawler can take other forms without deviating from the scope of the disclosed invention.

The intelligent file system crawler can identify each folder and assign an identification to the folder for comparison. The identification in one or more embodiments can take the form of a hash value that is based on the folder's characteristics. These characteristics are obtained by analyzing the folder's meta-data, which in one or more embodiments of the invention is stored in an embedded database and can contain attribute information, location information, and/or hash information for the folder, sub-folders, and/or files associated with the folder.

In one or more embodiments of the invention, the characteristics are used to produce a hash value that can be compared to other folders or meta-data stored in a successfully completed previous backup of the current file or folder. The hash value can be calculated using known method for calculating a hash value such as, but not limited to, MD4, MD5, SHA-1, SHA-2, and SHA-3. The identification in one or more other embodiments be related file/folder names, complete path of the file/folder, and/or any other useful means for identifying them.

Based on the identification or other characteristics of the folder, in step 304, the folder's attributes or characteristics can be compared with those collected for the same folder in a previous backup. In one or more embodiments of the invention this is done by comparing a current hash value of the folder with a hash value for the same folder that is stored in meta-data of the previous backup. Other characteristics of the folder, such as size or identification, can alternately or in addition, be compared in accordance with other embodiments of the invention.

In step 306, based on the comparison in step 304, the method determines if the folder's attributes match that of the attributes stored in the meta-data of the previous backup. If the attributes do not match, the method proceeds to have the intelligent file system crawler begin incrementally crawling the underlying sub-folders of the folder in step 308, which is described in more detail in the method of FIG. 4 below.

Once the sub-folders are crawled, the next targeted folder is crawled, and the method returns to step 302.

Returning to step 306, if the folder attributes do match those stored in the meta-data for the same folder in the previous backup, then the method proceeds to step 310. In step 310 it is determined if all targeted folders have been crawled. If all targeted folders have not been crawled, then the method proceeds to the next folder and step 302.

Otherwise, if all folders and underlying subfolders have been crawled in step 310, the method proceeds to step 312 where, the folder, each underlying sub-folder of the folder identified as having current attributes different from that of the attributes stored in the previous backup's meta-data, and any changed data within the folder and identified sub-folders are backed up in a new incremental backup of the target file system.

The method may end following step 312.

FIG. 4 shows a flowchart of a method of crawling the sub-folders of a target folder that has been determined to have attributes that do not match the meta-data of the previous backup in step 306 of FIG. 3. The method may be performed by, for example, a backup agent (102, FIG. 1) and/or intelligent file system crawler (210, FIG. 2) of a production host (104-106, FIG. 1). Other components of the system illustrated in FIG. 1 and FIG. 2 may perform all, or a portion of the method of FIG. 3 without departing from the invention.

While FIG. 4 is illustrated as a series of steps, any of the steps may be omitted, performed in a different order, additional steps may be included, and/or any or all the steps may be performed in a parallel and/or partially overlapping manner without departing from the invention.

In one or more embodiments of the invention, the method of FIG. 4 begins with crawling the next sub-folder of the target or current folder in step 400. When crawling the next sub-folder, the intelligent file system crawler identifies any files and/or underlying sub-folders in the sub-folder (or folder) currently being crawled.

In step 402, in accordance with one or more embodiments of the invention, the files or data stored in the sub-folder are indicated as needing to be backed-up in the incremental backup. These indications can be stored in a separate file or meta-data for use when backup agent backs up the data in the sub-folder. Alternatively, the indications can be stored in memory or in any other location that will allow the backup agent to easily determine which files/folders to include in the incremental backup and where they are physically located on the target host(s).

Next in step 404, the method determines if there are underlying folders present in the sub-folder. If yes, the method proceeds to step 406. If there are no underlying folders present, then the method proceeds to step 412.

In step 406, in one or more embodiments of the invention, the attributes of the current sub-folder are compared with the attributes for the current sub-folder stored in the meta-data of the previous backup for the current sub-folder. Based on this comparison, in step 408, if the attributes match those stored in the meta-data for the previous backup for the current sub folder, the method proceeds to step 412. If the attributes of the current sub-folder do not match the attributes in the meta-data of the previous backup of the current sub-folder, then the method proceeds to step 410 where an underlying sub-folder is considered and the method returns to step 400, where the underlying sub-folder is the next sub-folder.

Returning to step 412, in one or more embodiments of the invention, it is determined if additional sub-folders are present in the target folder. If additional sub-folders are present, then the method returns to step 400 and the method repeats for each sub-folder and underlying sub-folder. Otherwise, if no-additional sub-folder are present the method may end after step 412 and the method returns to step 302 of FIG. 3.

Additionally, as discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many distinct types of computing devices exist, and the input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention relate to generating backups of a file system. To improve the process of generating backups of a file system, one or more embodiments of the invention crawls only those folders which have changed. By comparing a folder's attributes with those in a backup's meta-data, an intelligent file system crawler can determine if the underlying files and sub-folders of the folder have undergone a change. If they have, then the one or more embodiments of the invention, proceed to crawl the underlying sub-folders. If the folder's attributes have not changed, then the intelligent file system crawler of one or more embodiments of the invention proceeds to the next folder. By doing this an intelligent file system crawler can crawl the entire file system quicker, since those folders that have not undergone a change since the last backup was performed, do not have their sub-folders crawled.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for performing an incremental backup on a target file system of a target production host, the method comprising:
identifying a folder in the target file system that is to be backed up;
initiating incremental crawling of underlying sub-folders of the folder when a folder's current attributes are different than a folder's attributes stored in a previous backup's meta-data,
in response to the initiating, crawling at least one underlying folder of the underlying sub-folders when the folder's current attributes are different than a sub-folder's attributes stored in the previous backup's meta-data; and
after the incremental crawling is completed backing up each underlying sub-folder of the folder identified as having current attributes different from that of the attributes stored in the previous backup's meta-data.

2. The method of claim 1, wherein each underlying sub-folder's sub-folders are incrementally crawled when the underlying sub-folder's current attributes are different than that of the underlying sub-folder's attributes stored in the previous backup's meta-data.

3. The method of claim 1, wherein the identifying is repeated for each folder in the target file system.

4. The method of claim 1, wherein the current attributes of the folder and the underlying sub-folders of the folder are determined by analyzing the folder's and/or sub-folders' meta-data.

5. The method of claim 4, wherein the folder's and/or sub-folders' meta-data is stored in an embedded database.

6. The method of claim 4, wherein the folder's and/or sub-folders' meta-data comprises at least one selected from a group consisting of attribute information, location information, and hash information.

7. The method of claim 1, wherein the previous backup's meta-data is from a successfully completed full backup.

8. The method of claim 1, wherein the previous backup's meta-data is from a successfully completed incremental backup.

9. A non-transitory computer readable medium comprising computer readable program code, which when executed by a computer processor enables the computer processor to perform a method for performing an incremental backup on a target file system of a target production host, the method comprising:
identifying a folder in the target file system that is to be backed up;
initiating incremental crawling of underlying sub-folders of the folder when a folder's current attributes are different than a folder's attributes stored in a previous backup's meta-data,
in response to the initiating, crawling at least one underlying folder of the underlying sub-folders when the folder's current attributes are different than a sub-folder's attributes stored in the previous backup's meta-data; and
after the incremental crawling is completed backing up each underlying sub-folder of the folder identified as having current attributes different from that of the attributes stored in the previous backup's meta-data.

10. The non-transitory computer readable medium of claim 9, wherein each underlying sub-folder's sub-folders are incrementally crawled when the underlying sub-folder's current attributes are different than that of the underlying sub-folder's attributes stored in the previous backup's meta-data.

11. The non-transitory computer readable medium of claim 9, wherein the identifying is repeated for each folder in the target file system.

12. The non-transitory computer readable medium of claim 9, wherein the current attributes of the folder and the underlying sub-folders of the folder are determined by analyzing the folder's and/or sub-folders' meta-data.

13. The non-transitory computer readable medium of claim 12, wherein the folder's and/or sub-folders' meta-data is stored in an embedded database.

14. The non-transitory computer readable medium of claim 12, wherein the folder's and/or sub-folders' meta-data comprises at least one selected from a group consisting of attribute information, location information, and hash information.

15. The non-transitory computer readable medium of claim 9, wherein the previous backup's meta-data is from a successfully completed full backup.

16. The non-transitory computer readable medium of claim 9, wherein the previous backup's meta-data is from a successfully completed incremental backup.

17. A system comprising:
a processor;
a storage device that stores at least one target file system that comprises of folders and files; and
a memory comprising instructions, which when executed by the processor, perform a method for performing an incremental backup on the at least one target file system, the method comprising:
identifying a folder in the target file system that is to be backed up;
initiating incremental crawling of underlying sub-folders of the folder when a folder's current attributes are different than a folder's attributes stored in a previous backup's meta-data,
in response to the initiating, crawling at least one underlying folder of the underlying sub-folders when the folder's current attributes are different than a sub-folder's attributes stored in the previous backup's meta-data; and
after the incremental crawling is completed backing up each underlying sub-folder of the folder identified as having current attributes different from that of the attributes stored in the previous backup's meta-data.

18. The system of claim 17, wherein each underlying sub-folder's sub-folders are incrementally crawled when the underlying sub-folder's current attributes are different than that of the underlying sub-folder's attributes stored in the previous backup's meta-data.

19. The system of claim 17, wherein the current attributes of the folder and the underlying sub-folders of the folder are determined by analyzing the folder's and/or sub-folders' meta-data.

20. The system of claim 19, wherein the folder's and/or sub-folders' meta-data comprises at least one selected from a group consisting of attribute information, location information, and hash information.
